(19) United States
(12) Patent Application Publication
(10) Pub. No.: US 2002/0050689 A1
(43) Pub. Date: May 2, 2002

(54) Minimal thickness, double-sided flanges for ultra-high vacuum components

(75) Inventor: Charles K. Crawford, Wilton, NH (US)

Correspondence Address: Hayes, Soloway, Hennessey, Grossman & Hage, PC, 175 Canal Street, Manchester, NH, 03101, US

(73) Assignee: Kimball Physics, Inc.

(21) Appl. No.: 10/014,164

(22) Filed: Oct. 26, 2001

Related U.S. Application Data
(60) Provisional application No. 60/243,526, filed on Oct. 26, 2000.

(51) Int. Cl. F16L 17/06

(52) U.S. Cl. 277/608

(57) ABSTRACT

A system for coupling ultra-high vacuum components specifically where a component is inserted between two standard thickness flanges. This system will minimize the length that is added onto a vacuum system when a component is added. The invention is a relatively thin flange including two sealing surfaces separated by a thin web. The thin flange of the present invention may be configured to mount a variety of equipment within a vacuum system, and/or provide connection between the interior of the vacuum system and the outside environment, such as electrical connection or fluid connection.

### CROSS-REFERENCE TO RELATED APPLICATIONS

The present application claims the benefit of U.S. provisional application serial No. 60/243,526, filed on Oct. 26, 2000, the teachings of which are incorporated herein by reference.

### FIELD OF INVENTION

This invention relates to ultra-high vacuum systems, specifically to a system for the insertion of components between two standard thickness flanges.

### BACKGROUND OF THE INVENTION

Vacuum systems find wide applications in research, education, product development, and production. Typical systems comprise independent and interchangeable components. Such components may include testing chambers, pumps, gauges, valves, specimen holders, testing apparatus, heating systems, and cooling systems.

Processes or experiments that require high or ultra-high vacuum (UHV) currently employ all metal vacuum joints. A typical all-metal joint, such as that disclosed in U.S. Pat. No. 3,208,758, is illustrated in FIG. 1. Such a joint comprises a flange 20, illustrated in FIG. 2, that includes an annular recess 26 and an annular knife edge 30. The flange 20 is configured for mating with another like flange 24 separated by a soft, metallic gasket 34. The opposing knife edges 30, 32 are pressed into the gasket 34 by tightening bolts 38 forming the UHV seal.

The force of the equally spaced bolts is transferred to the gasket through the thickness of the flange. The bolt holes are disposed on a diameter that is outside that of the knife edge. If the standard gasket is not of appropriate thickness, the flange will deform in the shape depicted in FIGS. 3 and 4 between opposing bolts 38. The bowing of the flange occurs due to the moment arm between the knife edge 30, 32 and the bolt 38. This may also create a wave-like deflection between the adjacent bolt holes. This shape is depicted in FIGS. 3 and 4. In the case of such a deflection or deformation, the gasket may leak if the force placed on the gasket between the adjacent bolts is less than the force required to press the knife edges sufficiently into the gasket to form a seal. Only an appropriate thickness of the flange provides resistance to bending deformation.

In UHV systems, the level of vacuum attainable is dependant upon the speed of the vacuum pumps, the leak rates of the vacuum joints and vacuum walls, the surface area of the chamber and pumping lines, and the surface roughness of the interior components. Cleanliness or purity of the vacuum environment depends upon the interior component's material, forming method, and surface finish. Additionally, the practicality of a vacuum system depends on the ease of access for changing specimens, the required downtime to troubleshoot and to make repairs, and the ease with which components can be added and removed from the system. The expense of a vacuum system lies in the cost of components, the required pump types and speeds, as well as the number and type of extra adapters needed to attach components to the system. Methods of accurately placing testing apparatus, processing equipment, or samples within a system are often required for an experiment or process. The prior art flanges, such as the one discussed above, do not completely optimize some of these requirements in some cases.

Methods for inserting or mounting apparatus in a vacuum system currently involve one of several options, all of which significantly increase size and/or complexity of the vacuum system. Typical apparatus mounting methods include inserting two thick flanges on each end of an extruded or welded tube, such as that illustrated in FIG. 5, where the tube or the flanges provide the mounting structure. Alternately, double-sided couplers, such as that shown in FIG. 5A, which bolt to the chamber and bolt to the apparatus may be employed. Couplers of this type not only add significant length and surface area, but also introduce inaccuracies to the system. Adding length and surface area decreases conductance (the ease at which gas can flow through the system) and increases the likelihood of contaminants in the system. With decreased conductance, a system will need larger, more expensive pumps in order to achieve the same vacuum level. The welded flanges have inherently poor parallelism that can cause problems if accurate placement of a component is required. While an existing system, or part of a system, can be modified to provide a mounting structure, that system, however, may be too large and cumbersome to be easily modified.

A large component, such as a pump, often cannot be mounted horizontally, or “cantilever style,” from a welded flange coupler without the aid of auxiliary support due to the weakness of the thin walled extension tube. Thin walled extension tubes also cannot accommodate internal mounting systems that require mounting grooves, such as those described in Crawford, U.S. Pat. No. 5,593,123, the teachings of which are incorporated herein by reference, in the extension tube wall.

The prior art for providing feed-through from the exterior atmosphere into a vacuum chamber is generally a single flange or welded feed-through. Both of these approaches require the testing apparatus to be independently mounted within the vacuum chamber and the feedthrough to be mounted on a chamber port. Under these circumstances, attachments, such as electrical wiring, must be done and redone whenever the apparatus is removed from the system. Having to needlessly redo complicated connections causes increased system downtime for repairs or component changes, and also leads to possible errors when re-connections are made.

The prior art valves between a vacuum chamber and another component are another source that can significantly decrease the vacuum system's conductance, and also require significant space. Generally, a valve is attached to a vacuum system using a coupler, such as that described previously, having a tapped through-hole. Therefore, anytime a valve is added to the vacuum system, a bulky coupler must be added, reducing the system's conductance.

### SUMMARY OF THE INVENTION

A system for the insertion of components between two standard thickness flanges of a vacuum system. The system herein comprises a thin flange configured to be disposed between and seal against two standard flanges of vacuum system components. The thin flange comprises sealing surfaces on opposed sides of the flange, such that a vacuum tight seal may be achieved when the thin flange is compressed between the two standard thickness flanges, wherein the thin flange experiences only symmetrical forces. The sealing surfaces of the thin flange may each comprise a knife edge disposed within the perimeter of the thin flange, whereby the knife edge may at least partially penetrate into a metal gasket when the thin flange is clamped between two standard thickness flanges. Advantageously, the thin flange may be equipped with one or more feed-throughs, openings, and/or mounting features for retaining apparatus in or around the vacuum system. The symmetry of the forces applied to the thin flange assure that the flange will not experience any bending, deflection, or distortion.

### BRIEF DESCRIPTION OF THE DRAWINGS

Exemplary embodiments of the invention are set forth in the following description and shown in the drawings, wherein:

FIG. 1 is a perspective view of a prior art all metal joint;

FIG. 2 illustrates a prior art seal in cross-sectional view;

FIG. 3 shows a distorted prior art flange in cross-sectional view;

FIG. 4 is a perspective view of a distorted gasket from a prior art all metal seal;

FIGS. 5 and 5A illustrate in perspective view prior art coupling members;

FIG. 6 is a perspective view of a thin flange consistent with the present invention;

FIG. 7 is a sectional view of the exemplary thin flange consistent with the present invention illustrated in FIG. 8A taken along cutting line A-A;

FIGS. 8 through 8B illustrate an exemplary embodiment of the thin flange consistent with the present invention;

FIG. 9 is a perspective view of an alternate exemplary thin flange consistent with the present invention;

FIG. 10 is a third illustrated exemplary embodiment of the thin flange consistent with the present invention shown in perspective view.

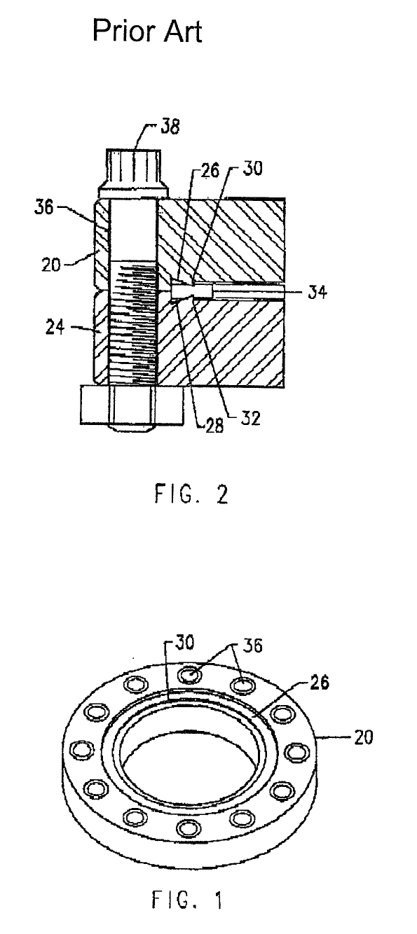

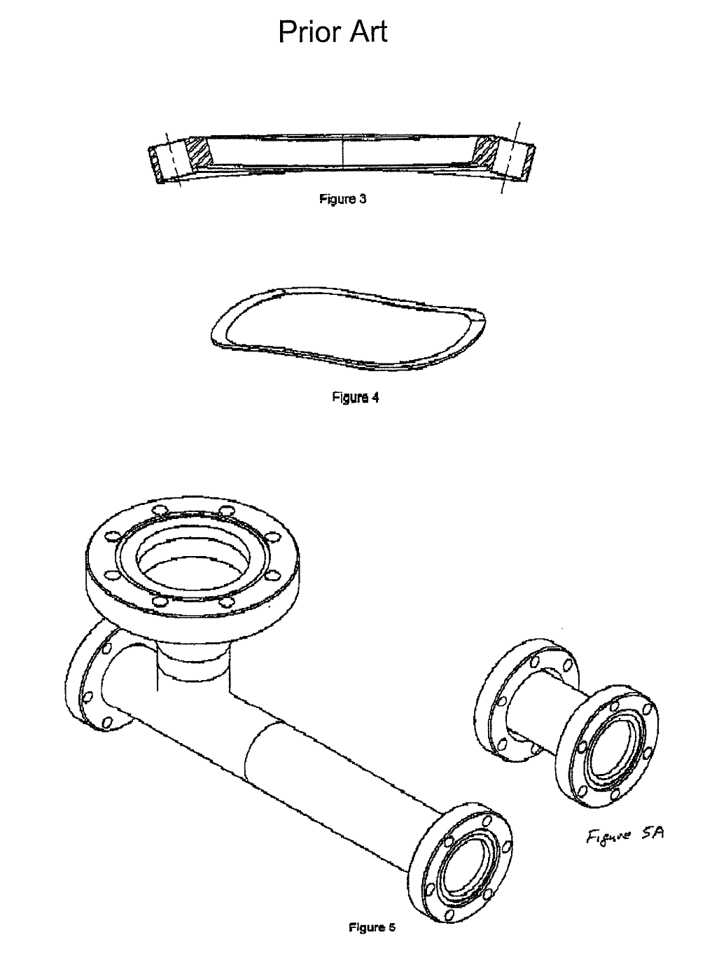

### DETAILED DESCRIPTION OF THE INVENTION

Referring to FIGS. 6 through 10, various exemplary embodiments of double-sided “thin flanges” consistent with the present invention are illustrated. It should be understood that the term “thin flange”, as used herein, is not so much an absolute dimensional characterization as it is a convenient designation, indicating that the flange is not required to be thick enough to withstand the stress and deflection imposed by the clamping bolts. The thickness of the flange is rather determined primarily by the thickness required to provide the instantly desired mounting characteristics or features—i.e., mounting grooves, threaded bores, feed-throughs, etc., as discussed in the following description of the invention.

FIGS. 6 through 8B show details of a first exemplary embodiment of a thin flange 40 having a sealing surface 42 to crush a pair of metallic gaskets 44A, 44B for forming an all-metal joint. A plurality of bolt holes 46 are located outside of the perimeter of the sealing surfaces 42 and 50 to provide a method of securing the thin flange 40 to another component 48 with a compatible sealing surface 50 before tightening the bolts 45. The bolt holes 46 provide alignment of the flange 40 relative to the other component 48 prior to sealing. However, once the seal is formed by tightening the bolts 45 and crushing the gaskets 44A and 44B, no support is provided to the flange by the bolts 45. The thickness of the thin flange 40 is optimized to provide adequate strength while maintaining a minimum thickness.

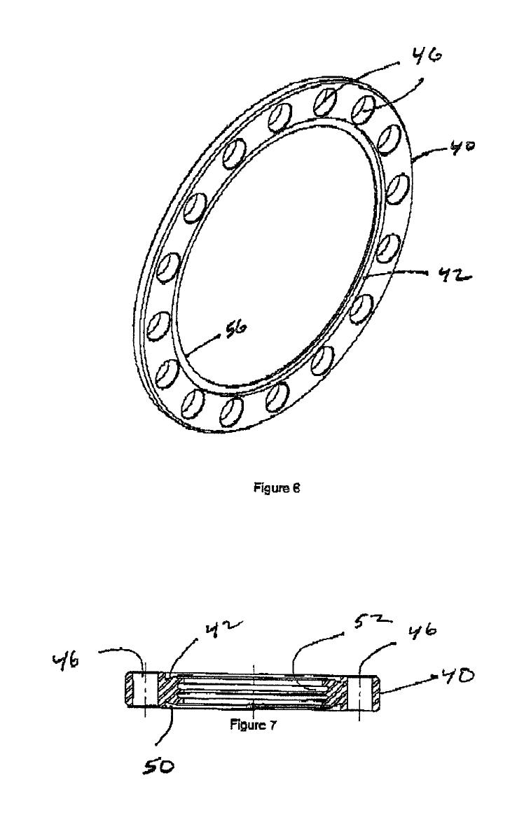

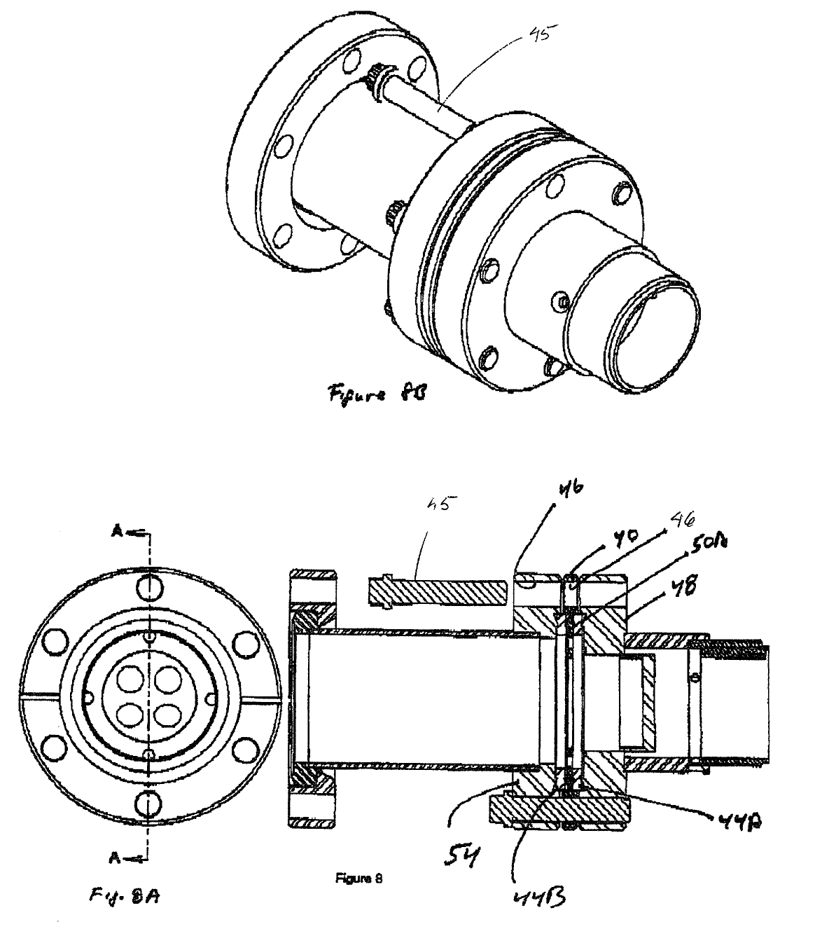

FIG. 7 is sectional view of the exemplary thin flange 40 taken along cutting line A-A referred to in FIG. 8A. This cross section shows the details of the sealing surfaces 42 and 50 including knife edges. Consistent with the present invention, internal vacuum components may be mounted using equipment-mounting grooves 52. These specific equipment mounting grooves 52 permit the mounting of internal vacuum system components (not shown) as described in Crawford U.S. Pat. No. 5,593,123. As illustrated, the equipment-mounting grooves 52 are disposed in a region of the thin flange 40 located within the perimeter of the mounting surfaces 42 and 50. Accordingly, components may be mounted extending out of the plane of the thin flange 40. Consistent with this configuration, components may be mounted to the vacuum system over a much shorter distance than previously possible because the thin flange 40 eliminates the need for a tube or double-sided coupler or an independent structurally thick double-sided flange. Not only does the decrease in length required to mount components make the system more convenient in space-limited applications, it also increases the conductance of the vacuum system.

Referring to FIG. 8, there is shown an exemplary thin flange 40 mounted between two standard thickness flanges 48 and 54. The two standard thickness flanges 48 and 50 are sealed against respective sides of the thin flange 40 by crush gaskets 44A and 44B. When the system is sealed by tightening the bolts 45, the force exerted on the standard thickness flanges 48 and 54 by the mounting bolts 45 is effectively transferred by the rigid body of the standard thickness flanges 48 and 54 to their respective sealing surfaces and knife edges which crush both metallic gaskets 44A and 44B. This, in turn, causes the crushed gaskets 44A and 44B to bear symmetrically against the inner web 56, which is best identified in FIG. 6. Accordingly, the thin flange 40 experiences only symmetrical compressive loading about its thickness. The bolt holes 46 of the thin flange 40 are under zero load. Furthermore, the thin flange 40 is not subject to any bending loads, as may be the case with the standard thickness flanges 48 and 54. This allows the thin flange 40 to be of a minimal thickness, only sufficient to resist the compressive forces and contain the knife edge sealing feature. Accordingly, the inserted member could be a membrane, window, or small aperture.

Turning to FIG. 9, there is illustrated a second exemplary thin flange 64. The second exemplary thin flange 64 is configured without bolt holes. The thin flange, according to this embodiment, allows for arbitrary radial alignment to the mating system. The greater flexibility in radial alignment of the thin flange 64 is capable because placement of the thin flange 64 relative to the standard thickness flanges (not shown) is not restricted by the need to align bolt holes in the thin flange 64 with the bolt holes in the standard thickness flanges. The thin flange 64 consistent with this exemplary embodiment is especially beneficial when an instrument or apparatus mounted to the thin flange must be precisely aligned either within the vacuum system, or relative to another instrument or apparatus.

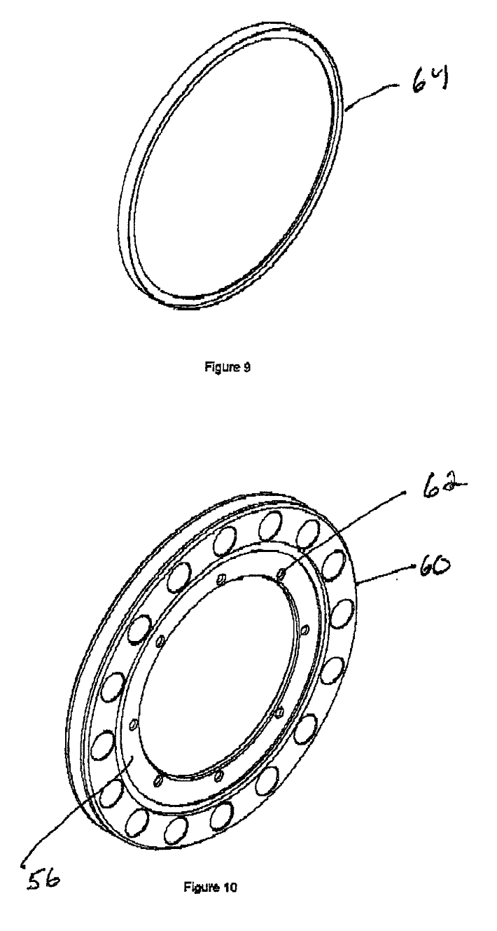

FIG. 10 illustrates in isometric view a third exemplary embodiment of a thin flange 60 consistent with the present invention. According to the third alternate embodiment, the thin flange 60 comprises a series of mounting holes 62 disposed about the inner web 56, inside the perimeter of the mounting surfaces of the flange 60. The mounting holes 62 may advantageously be configured to mount any variety of apparatus inside of the vacuum system. Accordingly, the mounting holes 62 may be arranged in a pattern that is generic to a variety of equipment, or the mounting holes 62 may be specially configured for individual pieces of apparatus. By employing a thin flange 60 as disclosed herein it is possible to align vacuum components and mating interior system components with a high level of dimensional precision.

In each of the above-described embodiments, the thin flange preferably is formed from a single unitary member. By machining the thin flange, including both of the sealing surfaces, from a single member it is possible to achieve very high tolerances. Additionally, it is possible to achieve a superior surface finish on the thin flange. This characteristic lends itself to higher conductance and greater cleanliness of the vacuum system, as well as accurate flange face parallelism.

Consistent with the above teachings, a thin flange of the present invention may be beneficially employed for mounting equipment within the vacuum system itself, as well as for an interface connecting items within the vacuum system to the exterior of the vacuum system. An exemplary application may be to conveniently provide an electrical feed-through for powering an apparatus inside the vacuum system while still maintaining the “vacuum tight” integrity of the system. Similarly, the inner web of the thin flange may be equipped with a valve, therein providing direct communication with interior of the vacuum system without decreasing the conductance of the system, which does result from typical valve mounting systems disposed on a couple or tube.

Further consistent with the exemplary embodiments illustrated in FIGS. 7 and 10, and discussed with reference thereto, the thin flange can mount an interior component, such as an electron gun, as well as provide an electrical feed-through. This is an improvement over having the electrical connections on a separate port of the vacuum chamber, as is conventionally the case. The advantage is that the connection does not need to be done at the location of the vacuum system since the component can be mounted within the thin flange and the electrical connections may be made as an independent subsystem. Should the component need to be removed from the vacuum system, the connection would not need to be disassembled and subsequently reassembled when the component was remounted. This saves time, and may reduce the number of ports required on a vacuum system's main chamber.

Further embodiments of the coupling flange obviously include different lengths, different industry standard flange sizes, different flange geometries, such as oval, rectangular, or other planar shape, and different interior mounting arrangements. On slightly thicker versions of the flange, radial ports may be added to increase access to internal components. Along the same lines, tees and crosses of various sizes can be envisioned. The thin flanges could also be stacked, with the limit only being the twist up and stretch of the set of bolts.

In consideration of the various above-described embodiments and applications consistent with the present invention, it will be readily appreciated that the thin flanges consistent with the present invention may advantageously be employed in a stacked manner. Consistent with this, a plurality of thin flanges may be disposed between two standard thickness flanges, thereby providing a variety of mounting features, feed-throughs, valves, etc., while requiring only one port on the vacuum system. Because each of the thin flanges consistent with the present invention contain two sealing surfaces, any number of thin flanges may be coaxially disposed, with each pair having a soft metallic gasket disposed therebetween. Furthermore, as in the case of a single thin flange disposed between two standard thickness flanges, each of the thin flanges in the above described “stack” will experience only symmetrical forces, generally only compressive in nature, and therefore will not be subject to distortion or deflection resulting from the clamping bolts. The exact number of thin flanges which may be stacked together is limited only the length of the clamping bolts employed with the standard thickness flanges.

Accordingly, it will be appreciated that the exemplary embodiments described and depicted in the accompanying drawings herein are for illustrative purposes only, and should not be interpreted as a limitation. It is obvious that many other embodiments, which will be readily apparent to those skilled in the art, may be made without departing materially from the spirit and scope of the invention as defined in the appended claims.

What is claimed is:

1. A thin flange for use with a vacuum system comprising;
a member having a first face having a sealing surface and an opposed, substantially parallel second face having a sealing surface, wherein the first face sealing surface and the second face sealing surface comprise a knife edge.

2. The thin flange according to claim 1 further comprising a plurality of through holes configured to be alignable with a plurality of bolt holes disposed in a standard thickness flange.

3. The thin flange according to claim 1 comprising at least one mounting feature disposed within a perimeter defined by at least a first sealing surface.

4. The thin flange according to claim 3 wherein the at least one mounting feature comprises at least one groove formed in an inner surface.

5. The thin flange according to claim 3 wherein the at least one mounting feature comprises at least one threaded bore.

6. The thin flange according to claim 1 comprising at least one feed-through.

7. A vacuum component mounting system comprising:
a first flange having a sealing surface and a second flange having a sealing surface,
a thin flange disposed between the first flange and the second flange, the thin flange comprising a first sealing surface and a second sealing surface being configured to interact with the first flange sealing surface and the second flange sealing surface respectively and thereby form a vacuum tight seal.

8. The vacuum component mounting system according to claim 7 wherein the thin flange is retained between the first flange and the second flange by a clamping force urging the first flange toward the second flange.

9. The vacuum component mounting system according to claim 7 wherein the thin flange contains at least one mounting feature.

10. The vacuum component mounting system according to claim 9 wherein the at least one mounting feature comprises at least one threaded bore.

11. The vacuum component mounting system according to claim 9 wherein the at least one mounting feature comprises at least one groove formed on an inner surface of the thin flange.

12. The vacuum component mounting system according to claim 7 wherein the thin flange comprises at least one feed-through.

13. The vacuum component mounting system according to claim 7 wherein the thin flange comprises a plurality of through holes configured to be alignable with a plurality of bolt holes disposed in the first flange and in the second flange.
